(19) United States
(12) Patent Application Publication
(10) Pub. No.: US 2024/0199388 A1
(43) Pub. Date: Jun. 20, 2024

(54) WINCH

(71) Applicant: Dmitrijs Volohovs, Riga (LV)

(72) Inventor: Dmitrijs Volohovs, Riga (LV)

(21) Appl. No.: 18/555,729

(22) PCT Filed: May 5, 2022
(86) PCT No.: PCT/IB2022/054143

§ 371 Date: Oct. 17, 2023

Related U.S. Application Data
(60) Provisional application No. 63/184,810, filed on May 6, 2021.

(51) Int. Cl. B66D 1/48; B66D 1/20

(52) U.S. Cl. CPC B66D 1/485; B66D 1/20; B66D 2700/0183

(57) ABSTRACT

We generally describe a winch (100) comprising: a plurality of ropes (130, 140) coupleable to a first load (200) or to different respective second loads (200, 210); a support frame (110); and a first roller (150) moveably coupled to the support frame (110), wherein a first rope (150) of the plurality of ropes (130, 140) is moveable over the first roller (150); wherein a movement of the first roller (150) is configured to shorten and/or lengthen a usable length of the first rope (140) of the plurality of ropes (130, 140), and wherein the shortening and/or lengthening of the usable length of the first rope (140) is configured to raise and/or lower the first load (200) or one of the second loads (200, 210) to which the first roller (150) is coupleable via the first rope (140).

### FIELD OF THE INVENTION

The present invention generally relates to a winch comprising a plurality of ropes, in some implementations a motor and/or a shaft, and one or more rollers and a support frame. The present invention allows in particular for the lowering and/or raising of a load coupled to the plurality of ropes when the load needs to be raised and/or lowered at an angle. The present invention may achieve this by using at least one moveable roller (i.e. a position of the roller in the winch may be moved).

### BACKGROUND TO THE INVENTION

Prior art systems achieve the raising and lowering of a load at an angle (e.g. to adjust the load angle and position) by using a plurality of winches. This results in a very large apparatus that is not suitable for compact spaces. Additionally, all winches need to be operational at the same time. Therefore, in the prior art, if one winch fails, all of the winches carrying the load need to be deactivated. Furthermore, data relating to each winch needs to be relayed to the other winches within the system thereby leading to a higher chance of corrupted and/or unusable data.

There is therefore a need for an improved winch.

### SUMMARY OF THE INVENTION

The invention is set out in the independent claims. Preferred embodiments of the invention are outlined in the dependent claims.

According to a first aspect, we describe a winch comprising a plurality of ropes coupleable to a first load or to different respective second loads, a support frame, and a first roller moveably coupled to the support frame, wherein a first rope of the plurality of ropes is moveable over the first roller, wherein a movement of the first roller is configured to shorten and/or lengthen a usable length of the first rope of the plurality of ropes, and wherein the shortening and/or lengthening of the usable length of the first rope is configured to raise and/or lower the first load or one of the second loads to which the first roller is coupleable via the first rope. The winch comprises a plurality of ropes so that that ropes can be coupled to the load(s) at multiple points of the load(s) (i.e. the ropes can be coupleable to the same single load, or they can be coupled to two or more loads. In particular, each rope may be coupled to a corresponding, respective load. In other cases, one or more ropes may be coupled to a first load and one or more other ropes may be coupled to a second load different from the first load) and thus lead to the load(s) being able to be orientated at an angle via load manipulation (raising and/or lowering). This in turn may lead to the ability of the load to be raised and lowered at an angle. The load may be a lighting or non-lighting device and/or an electro/electronic device and/or a decorative device and/or an ordinary cargo load or any other type of load.

The movement of the moveable roller may allow for the roller to be placed in a known position and may allow for at least one of the plurality of ropes to be lengthened or shortened without, in some examples, effecting the lengths of the other ropes. This in turn may lead to the load(s) being manipulated so that the load(s) can be tilted at different angles and raised and/or lowered. In some examples, there is a plurality of moveable rollers comprised in the winch.

In some examples, the winch is one of a plurality of winches controlled by a main controller. In such examples, each winch of the plurality of winches may comprise a single rope coupleable to at least a first load, which may allow for the system of winches to be adapted so as to be suitable for a safe operation of the system.

In some examples, the usable length of the first rope is a length between the first roller and a coupling of the first rope to a said first load or to a said respective second load. Throughout the present disclosure, the term “usable length” may be understood as this definition, i.e. in that it defines a length between a roller over which a rope travels and a coupling at which the rope is coupled or coupleable to a load. In some examples, the measuring point may not be the first roller but may be a predetermined point on the winch, for example a different roller or any other suitable point.

Example implementation described throughout the present disclosure allow for a compact winch design and improved safety. The usable length of one or more ropes is adjustable and may, in some examples, be within a travel length of a motor (for example, a linear motor). Even if a motor fails, safety is not affected due to limits of the usable length of a rope not being exceeded. No external safety device may be required when operating the winch as described throughout the present disclosure.

In some examples, the winch further comprises a second roller, wherein the second roller is fixably coupled to the support frame, and wherein the first rope of the plurality of ropes is moveable over the second roller.

The plurality of rollers allows the rope (or ropes) to be guided around the winch. The configuration of the rollers allows for the rope (or ropes) to be arranged in such a way so that the length of each rope can be adjusted independently via the at least one moveable roller. It further allows for a longer lifetime of the ropes as they are prevented from sliding against each other. It may also allow for a more accurate measurement of the usable length of the rope that moves over the roller. It may allow for a safer construction of the winch as the rope may be put under less strain. Guidance of a rope over multiple rollers may also improve safety due to a probably of the rope sliding or jumping off a roller may be reduced.

In some examples, the position of the second roller is adjustable. The position may be changed by moving the roller to a different part of the winch and coupled there by any suitable means. This may allow for the lengths of the ropes and for the winch to be customizable according to the load to be raised and lowered.

In some examples, the first roller is coupled to an elongated member, wherein the elongated member is rotatable about a longitudinal axis of the elongated member, and wherein upon a rotation of the elongated member about the longitudinal axis, the first roller is configured to move along said longitudinal axis of the elongated member.

The elongated member is preferably orientated substantially perpendicular to the plane of the raising and the lowering of the load (i.e gravity). Alternatively, the elongated member may be orientated in any direction. The elongated member may be coupled to any number of moveable rollers. In some examples, there may be a plurality of elongated members. The elongated member is preferably a worm screw or a trapezoidal screw, but can be any type of elongated member, e.g. shaft or screw, that allows the coupled moveable roller to move along the elongated member in the axial direction of the elongated member. The positioning of the elongated member in relation to the first roller may allow for the ropes to have a longer lifetime as they are not in danger of sliding against the elongated member. It may additionally or alternatively allow for easier maintenance of the winch as the elongated member is in an easy to reach place.

In some examples, the support frame comprises a support frame opening. In some examples, the elongated member is coupled to the first roller through this support frame opening i.e. the elongated member is on one side of the opening and the first roller is on the other side of the opening. This may allow for the ropes to have a longer lifetime as they are not in danger of sliding against the elongated member. It may additionally or alternatively allow for easier maintenance of the winch, as the elongated member is in an easy to reach place.

In some examples, the support frame opening is substantially in line with the elongated member. This may alloy for a safe operation of the winch as the ropes have a lower likelihood of passing through the opening. Furthermore, it may also allow for a longer lifespan of the ropes, as they have a lower likelihood of contacting the rotating elongated member.

The longitudinal axis of the elongated member may be defined as an axis running through the center of the elongated member from one end to the other. In some examples, the elongated member is not rotated about its longitudinal axis and other means may be provided for moving a roller.

In some examples, each of the rollers is coupled to the support frame by a respective roller support. Each roller may have its own roller support or multiple rollers may be coupled to a single roller support. This may allow for the rollers to be located in a position proximate to the support frame. This may also allow for a longer lifetime of the ropes, as they are prevented from sliding against the support frame. It also may allow for easier maintenance of the ropes, as they can be accessed more easily.

In some examples, the moveable roller is coupled to the elongated member via the roller support the roller is coupled to. This may allow for a stable construction of the coupled moveable roller as it is moved. The roller support which couples the moveable roller to the elongated member may comprise a thread which corresponds to the thread of the elongated member. This may allow for the roller support, and thereby the roller, to move along the longitudinal axis of the elongated member when the elongated member is rotated.

In some examples, the elongated member is rotated by a first motor. The first motor may be coupled to a first motor driver circuit. The first motor driver circuit may comprise a processor and a memory configured to control the first motor. The memory may contain predetermined instructions to control the first motor driver circuit via the processor. The first motor driver circuit may comprise a transceiver unit configured to send and/or receive data (wirelessly or via a wired connection) and control signals to and/or from an external controller. The external controller may be a computer, a mobile phone, a server or any other suitable controller. The first motor may preferably be a linear motor.

In some examples, the winch further comprises a switch contactable by the first roller, wherein upon an establishment of a contact between the first roller and the switch, the winch is configured to detect a position of the first roller. Additionally or alternatively, the (first) roller support to which the roller is coupled to may contact the switch. Additionally or alternatively, the winch may further comprise a detection device configured to detect the position of the roller coupled to the elongated member. The detection device may be an optical detector and/or a radio detector configured to measure distance and/or any other suitable type of detector. The detection device may be coupled with one or more of the motor driver circuits. The detection device may comprise a transceiver unit configured to send and/or receive data and control signals to and/or from an external controller and/or any of the other components of the winch. The switch and/or the detection device may allow for the likelihood of damage to the winch to be reduced, as it may prevent excess movement of the first roller and/or overwinding of the elongated member and/or the winch (e.g. a winch drum).

In some examples, during a setup procedure of the winch, the elongated member is configured to be rotated in a first rotational direction about the longitudinal axis to move the first roller towards the switch, and wherein upon said establishment of the contact between the first roller and the switch, the elongated member is configured to be rotated in a second rotational direction about the longitudinal axis to move the first roller away from the switch to a position with a known first distance, L1, from the switch, wherein the second rotational direction is opposite to the first rotational direction. In some examples, this known first distance is a midway point of the elongated member. The above-specified procedure may allow for the first roller to be calibrated to a known position before the load is raised or lowered, thereby reducing the likelihood of excess movement of the first roller and/or overwinding of the elongated member and/or the winch (e.g. a winch drum). This may also result in a reduced probability of the load being moved while in the wrong orientation, thereby reducing the probability of the load being damaged. In some examples, the switch is located at one end of the elongated member. Alternatively, the switch may be located at any point of the elongated member. In some examples, there are a plurality of switches.

In some examples, the winch further comprises a second motor, wherein the plurality of ropes are lengthened and/or shortened by the second motor. The second motor may be coupled to each of the plurality of ropes. The second motor may be dependent or independent of the first motor. The second motor may preferably be a linear motor.

In some examples, the winch further comprises a second motor driver circuit configured to control the second motor. The second motor driver circuit may allow for the second motor to be controlled in a predetermined way. The second motor driver circuit may comprise a processor and a memory configured to control the second motor. The memory may contain predetermined instructions to control the second motor driver circuit via the processor. The second motor driver circuit may comprise a transceiver unit configured to send and/or receive data and control signals to and/or from an external controller. The first and second motor driver circuits may function dependent or independent from each other. In some examples, there is more than one motor driver circuit per motor. In some examples, there are more than two (linear) motors and more than two motor driver circuits.

In some examples, the second motor is coupleable to a rotatable drum and the plurality of ropes are wound around the rotatable drum. This may allow for a particularly controlled and safe method of raising and/or lowering the load.

In some examples, the rotatable drum comprises grooves to hold the plurality of ropes. In some examples, each groove holds a plurality of the plurality of ropes. Alternatively, each groove holds only one of the plurality of ropes. The width of each groove in the drum may be the same. This may allow for the ropes to be wound and unwound at the same rate, thereby leading to an even raising and/or lowering of the load.

The winch according to example implementations outlined throughout the present disclosure may allow for the rope lengths of one or more of the plurality of ropes to be within the limits of the travel lengths of the linear motors independent of the values that are sent to the winch, or even if the values are corrupted or incorrect. The winch may also allow that, in the event any of the motors of the winch fail, safety is not effected, as the limits of the rope of ropes are not exceeded. Thus, there may be no need for any external safety devices.

In some examples, the second motor is coupled to an additional elongated member instead of a rotatable drum, wherein the additional elongated member is coupled to a second moveable roller and wherein the plurality of ropes is configured to move over the second moveable roller. This may allow for a particularly compact winch design, as there is no need for a rotatable drum.

In some examples, after the first roller has been moved to the position with the known first distance, the second motor and a gearbox coupled to the second motor wind the plurality of ropes to a first known position, and wherein after the plurality of ropes have reached the first known position, the second motor is stopped and the second motor is activated in the opposite direction so that the plurality of ropes are located in a second known position. This may allow for a reduction in the chance of the load making contact with the winch, thereby reducing the change of damage to both the winch and the load. This may also allow for the motors and the motor driver circuits to be calibrated before further movement of the load.

In some examples, the winch further comprises a common support which is moveably coupled to the support frame, and a third roller and a fourth roller fixably coupled to the common support, wherein a movement of the common support is configured to move the first load or one or more second loads in a direction having a component perpendicular to gravity. This may allow for a particularly safe method of moving the load in a horizontal direction. In some examples, the third roller may be the same as the first and/or second roller, and the fourth roller may be the same as the first and/or second roller. The rollers may be fixably coupled to the common support in a similar manner as to how the second roller is fixably coupled to the support frame as described above. The orientation of the common support may be fixed. This orientation is preferably 45 degrees to the ground plane (or 45 degrees with respect to the direction of gravity), but may be any suitable angle. The orientation of the common support may be able to be changed while the winch is not in operation. This may allow for the ropes which pass over the common support to be positioned and coupled to the load at points which allow for a safe operation of the winch no matter the shape or size of the load. The common support may be any suitable shape or design which allows for safe operation of the winch.

In some examples, the winch further comprises an extension arm comprising a fifth roller, wherein one or more of the plurality of ropes is moveable over the fifth roller. The extension arm may allow for a particularly safe method of coupling a bulky load to the winch. In some examples, the fifth roller may be any one of the first to fourth rollers. In some examples, there are a plurality of rollers on the extension arm.

In some examples, the extension arm is moveable from a position adjacent to the support frame to a position not adjacent to the support frame. This may allow for the connection points of the ropes to the load to be customized according to the load, thereby allowing for a safer operation of the winch. It may also allow for the connection points to be adjusted during the operation of the winch. The arm may be a telescopic arm. The arm may be coupled to the support frame by a hinge or any other suitable means.

In some examples, the winch further comprises a rope extender which comprises a plurality of extension arms, and wherein the rope extender is suspended from the winch. This may allow for the winch to be coupled to bulky loads in a particularly safe manner. In some examples, one or more extension arms comprise an overwind marker (i.e. overwind sensor) and/or an overwind detector as described in further detail below. The rope extender may alternatively or additionally comprise a proximity sensor attached to one or more of the extension arms.

In some examples, at least one of the plurality of ropes is directly coupled (i.e. connected) to the support frame. This may allow for a particularly safe coupling of a rope whose usable length does not need to be adjusted. In some examples, power and/or data is transferred from a power/data source coupled to the support frame to the load via the directly coupled rope. In some examples, the directly coupled rope does not move over any rollers. This may result in a particularly stable transfer of power and/or data from the power/data source to the load. Such stable transfer of power and/or data may further improve safe operation of the winch.

In some examples, the second loads are aligned in a direction substantially parallel to a direction of gravity, and wherein at least one of the second loads comprises a pass through hole configured to allow at least one of the plurality of ropes to pass through the at least one second load. This may allow for the at least one rope to be protected from outside elements as it is partially concealed within the load. This in turn may allow for a longer lifespan of the rope. The pass through hole may additionally or alternatively allow for the at least one rope to hang relatively straight as it does not need to divert around the load. This may result in a particularly stable transfer of power and/or data from the power/data source to the load. Such stable transfer of power and/or data may further improve safe operation of the winch. The pass through hole may be used so that one load is placed above the another load, where the top load has a said pass through hole (opening) for the rope coupled to the lower load to penetrate the pass through hole. More than two loads may be placed above each other.

In some examples, the movement of the first roller lengthens and/or shortens a length of the second rope of the plurality of ropes. This may result in the load being angled, as only one of the ropes is raised and/or lowered. Alternatively, a length of the first rope of the plurality of ropes may be raised and/or lowered. Alternatively, the lengths of a plurality of the plurality of ropes may be lengthened and/or shortened.

In some examples, at least one of the plurality of ropes comprises an overwind marker. The overwind marker on at least one of the ropes may give the winch the ability to prevent overwinding of the plurality of ropes. This may lead to a reduced possibility of damage to both the winch and the load as the two are prevented from contacting each other. The overwind marker may be an element added to the rope such as a knot or other suitable physical element and/or a piece of the rope colored differently to the rest of the rope and/or any other suitable marker.

In some examples, the winch further comprises an overwind detector coupled to the support frame and configured to detect the overwind marker on the at least one of the plurality of ropes. The overwind detector may allow for the prevention of the overwinding of the rope and may lead to a reduced chance of damage to the winch and to the load. The overwind detector may be a detector which detects anomalies in the rope if the overwind marker is, for example, a knot or other suitable physical marker. Additionally or alternatively, the overwind detector may be an optical detector configured to detect changes in color of the rope if the overwind marker is a different color from the rest of the rope. Additionally or alternatively, the overwind detector may be any kind of detector suitable for detecting the overwind marker.

In some examples, a second distance between the overwind marker and a coupling point to the load of the at least one of the plurality of ropes to which the overwind marker is coupled, is equal to or greater than a third distance between the first and second rollers. This may reduce the likelihood of the load making contact with the winch, thereby reducing the chance of damaging one or both of them.

In some examples, the movements of the winch are controlled by a microcontroller. The microcontroller may be coupled to one or more of the motors and/or motor driver circuits and/or one or more of the other electronic components on the winch. The microcontroller may comprises a transceiver unit configured to send and/or receive data and control signals to and/or from an external controller. The microcontroller may allow for easy management of the winch. The microcontroller may be configured to send power and/or data to and/or receive power and/or data from the load(s).

In some examples, the winch further comprises a third rope configured to move over at least one additional roller fixably coupled to the support frame. This may be particularly advantageous for large, bulky loads and/or loads that require movement in three dimensions.

In some examples, the at least one additional roller is coupled to a second elongated member and a third motor drive circuit. The second elongated member and the third motor drive circuit may be similar to the elements described above in relation to the elongated member and the first motor drive circuit. The second elongated member and at least one additional roller may lengthen and/or shorten the length of the third rope. This may result in a particularly efficient way for the winch to move the load in three dimensions.

In some examples, the winch further comprises a second detection device and/or a second switch configured to detect the position of the at least one additional moveable roller coupled to the second elongated member. The second detection device may be an optical detector and/or a radio detector configured to measure distance and/or any other suitable type of detector. The second detection device may be coupled with one or more of the motor driver circuits. The second detection device may comprise a transceiver unit configured to send and/or receive data and control signals to and/or from an external controller and/or any of the other components of the winch. The second switch may be of construction as the switch described above in relation to the first roller.

In some examples, the roller support which couples the second elongated member and the at least one additional roller may be located in a second opening of the support frame. The second opening may preferably be aligned with the second elongated member. This may allow for the ropes to have a longer lifetime, as they are not in danger of sliding against the second shaft.

In some examples, at least one of the plurality of ropes is configured to supply power and/or data to the said load. This may be particularly advantageous if the load is a powered load. The rope may supply positive and/or negative power. In some examples, the rope is a grounding rope. In some examples, one rope may be a positive power supply and another rope a negative power supply. Additionally or alternatively, one or more of the plurality of ropes is electrically conductive.

In some examples, the winch further comprises a data and/or power connector configured to supply data and/or power to the load and/or the electronic components in the winch. This may allow for a singular point where all power and/or data for power and/or data transmission in the winch. The data and/or power connector may be coupled to one or more electronic components of the winch. The data and/or power connector may comprise a transceiver unit configured to send and/or receive data and control signals to and/or from an external controller and/or any of the other components of the winch. The data and/or power connector may be coupled to the support frame.

We further describe a method for controlling a winch wherein the winch comprises a plurality of ropes coupleable to a first load or to different respective second loads, a support frame, a first roller moveably coupled to the support frame, wherein a first rope of the plurality of ropes is moveable over the first roller, and a winch controller configured to move the first roller or to provide an output signal for moving the first roller, and wherein the method comprises, receiving, by the winch controller, from the winch, data comprising positional data of at least one of the plurality of ropes and/or a said first or second load, determining, by the winch controller, if the received data fulfils a condition, wherein, if the condition is fulfilled, the method further comprises, calculating, by the winch controller, length data relating to a usable length of at least one of the plurality of ropes, wherein the usable length is changeable and/or a position of a said first or second load is raisable and/or lowerable by the winch, and moving the first roller to a location defined by a length difference which is determined based on the calculated length data and the received data, wherein the movement is configured to change the usable length of the at least one of the plurality of ropes and/or raise and/or lower a said first or second load.

The winch described in relation to the method above may be substantially or exactly the same as the winch described according to any one or more of the example implementations outlined herein and in particular outlined above.

In some examples, the winch may comprise a single rope coupleable to at least a first load. A system of winches may then be provided, with each winch having a single load. In this example, the method may be adapted so as to be suitable for a winch of the plurality of winches with a single rope each. As will be appreciated, any one or more of the example implementations outlined herein may also be used in systems with one or more winches having only a single rope, and one or more other winches having a plurality of ropes.

The method may allow for the rope lengths of one or more of the plurality of ropes to be within the limits of the travel lengths of linear motors independent of the values that are sent to the winch, or even if the values are corrupted or incorrect. The method may also allow that, in the event a motor or any of the motors of the winch fail(s), safety is not effected, as the limits of the rope(s) are not exceeded. Thus, there may no need for any external safety devices.

The expression “usable length” may be understood as being defined in the same manner as described above in relation to example implementations of the winch.

The winch controller may be substantially or exactly the same as the microcontroller described in relation to the example implementations of the winch outlined above. The winch controller may comprise the first motor or, alternatively, be electrically coupled to the first motor.

The positional data may comprise data about the usable length of one or more of the ropes and/or data about the load(s). The data may additionally comprise any suitable data. In some examples, the data is received in the form of a data packet.

The condition in the determination step may comprise comparing the received data to a data stored in the winch controller and thereby checking for compatibility, i.e. if the forms (format and/or values and/or entries) of the data are the same, if the data is the correct data for the winch should the winch be part of a plurality of winches or any other suitable method of determining if a condition has been fulfilled. Fulfilling the condition may allow for a particularly safe operation of the winch as the winch may not continue with the method if the condition is not fulfilled, as is described below.

In some examples, the calculation comprises calculating the positon of a center of the load in relation to the winch, the tilt angle of the load and the direction angle of the load. This method may be particularly advantageous for larger loads and for loads which require a large number of ropes.

In some examples, the calculation comprises calculating one or more of a positon of a gravitational center of a (first and/or second) load; a geometric center of a said first and/or second load, a geometric center of couplings of the plurality of ropes to a said first and/or second load; a tilt angle of a said first and/or second load; and a direction of a tilt of a said first and/or second load. This may allow for detailed data to be calculated by the winch controller, thereby leading to a safer operation of the winch as the controller can monitor more parameters for failure. It may also allow for a more detailed (i.e. precise) manipulation (raising and/or lowering) of the load (or one or more parts of the load).

In some examples, the calculation comprises calculating the usable length of each rope of the plurality of ropes. This may allow for detailed data to be calculated by the winch controller, thereby leading to a safer operation of the winch as the controller can monitor more parameters for failure. It may also allow for a more detailed (i.e. precise) manipulation (raising and/or lowering) of the load (or one or more parts of the load).

In some examples, if the condition is not fulfilled in the determination step, the winch controller prevents or stops calculating the length data and/or moving the first roller. This may therefore allow for a particularly safe operation of the winch, as the method is prevented from continuing if the data is wrong or corrupted.

In some examples, the winch controller comprises a processor and a memory configured to control the winch controller. The memory may contain predetermined instructions to control the winch controller via the processor. Additionally or alternatively, the winch controller may comprise a transceiver unit configured to send and/or receive data and control signals to and/or from an external controller and/or one or more winches and/or the one or more motors within the one or more winches.

In some examples, in an initial step, the winch is powered up by the winch controller. The winch controller may power up the winch via an instruction directly input to the winch controller and/or an instruction received from an external controller via the transceiver.

The winch described herein and the associated method may allow for a very safe method of moving loads. In particular, regardless of the values sent to the winch controller, or even if the values are corrupted or incorrect, the physical rope lengths will be within the limits of the travel lengths of the linear motors and the elongated members (e.g. shafts) coupled to said linear motors. Even if any of the motors fail, safety will not be effected as the limits will not be exceeded. Thus, there is no need for an external safety device.

Even if some of the aspects described above have been described in reference to the winch only, these aspects may also apply to the method, and vice versa.

### BRIEF DESCRIPTION OF THE DRAWINGS

These and other aspects of the invention will now be further described, by way of example only, with reference to the accompanying figures, wherein like reference numerals refer to like parts, and in which:

FIGS. 1a and b show front views of a schematic illustration of a winch according to some example implementations described herein;

FIGS. 2a and b show a front and rear views, respectively, of a schematic illustration of a winch according to some example implementations described herein;

FIGS. 3a to c show front views of a schematic illustration of a winch according to some example implementations described herein;

FIG. 4 shows a front view of a schematic illustration of a winch according to some example implementations described herein;

FIGS. 5a and b shows perspective views of a schematic illustration of the coupling between the rope and the load according to some example implementations described herein;

FIGS. 6a and 6b show front views of a schematic illustration of a winch according to some example implementations described herein;

FIG. 7a shows a front view of a schematic illustration of a winch according to some example implementations described herein;

FIG. 7b shows a load manipulated by the winch according to some example implementations described herein;

FIG. 8a shows a perspective view of a schematic illustration of a winch configuration according to some example implementations described herein;

FIG. 8b shows a block diagram of a plurality of winches according to some example implementations described herein;

FIG. 9a shows a perspective view of a schematic illustration of a winch configuration according to some example implementations described herein;

FIG. 9b shows a side view of a load manipulated by the winch according to some example implementations described herein;

FIGS. 10a and 10b show examples of data tables processed by the winch according to some example implementations described; and

FIG. 10c shows a block diagram of a method of controlling a winch according to some example implementations described herein.

### DETAILED DESCRIPTION OF PREFERRED EMBODIMENTS

In the examples described herein, the winch is orientated such that the load is lowered (or raised) in a direction parallel or substantially parallel to the direction of gravity.

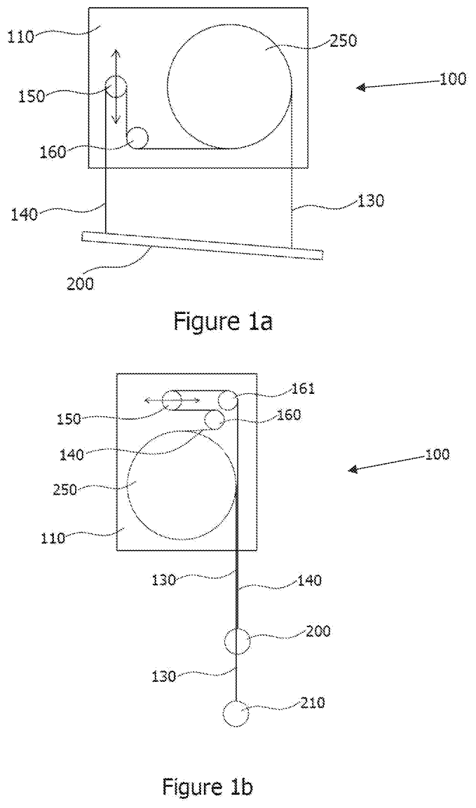

FIGS. 1a and 1b show front views of a schematic illustration of a winch 100 according to some example implementations described herein.

FIG. 1a shows a winch 100 comprising a support frame 110, a rotatable drum 250, and two ropes 130, 140 wound on the rotatable drum 250. The two ropes 130, 140 are wound on the same rotatable drum 250 in order to ensure that the ropes 130, 140 are raised and lowered at the same rate during the operation of the winch 100.

The rotatable drum 250 may comprise grooves configured to keep the ropes 130, 140 in place and to prevent them from sliding against each other. Each groove on the rotatable drum 250 may hold a single rope 130, 140 or each groove may hold both ropes 130, 140. Each groove may hold only a single winding of the rope 130, 140 or alternatively, each groove may hold multiple windings.

The first rope 130 is directly connected to the (single) load 200 on one side of the load 200. The second rope 140 is guided through the winch 100 via the fixed roller 160 and then via the movable roller 150 (moveably coupled to the support frame 110) and is then directly coupled to the other side of the load 200. In some examples, one or more of the ropes 130, 140 are not directly connected to the load 200.

The fixed roller 160 is directly coupled to the frame 110 of the winch 100. The moveable roller 150 is moved by a linear motor in a vertical direction i.e the direction of the arrows. Alternatively, the moveable roller 150 may be moved in the horizontal direction or any other suitable direction. The linear motor and the movement of the moveable roller 150 will be described in further detail below.

As the movable roller 150 is moved up and down by the linear motor, the length of the second rope 140 is changed. As a result, one side of the load 200 is raised or lowered. This leads to the load being at an angle, as shown in FIG. 1a. The movement of the moveable roller 150, and thus the length of the second rope 140, may be done separately or simultaneously to the rotation of the drum 250. This allows for both the angle and the height of the load 200 to be changed simultaneously.

FIG. 1b shows a winch 100, a support frame 110, a rotatable drum 250 and two ropes 130, 140 wound on the drum 250 in a similar manner to that described in relation to FIG. 1a. The first rope 130 is passed through the first load 200 and coupled to the second load 210. The second rope 140 is guided through the winch 100 via the fixed roller 160 and then via the movable roller 150 and is coupled to load 200. Thus, the first load 200 is movable in a vertical direction relative to the second load 210. This allows for the distance between the two loads 200, 210 to be increased or reduced according to the specific needs of the loads 200, 210 by moving the moveable roller 150 in the direction of the arrows i.e. the horizontal direction. Furthermore, both loads 200, 210 can be moved simultaneously up/down by rotating the rotatable drum 250. In some examples, the roller 150 may (alternatively or additionally) be movable in a different direction to the one indicated in via arrows in FIG. 1b, in order to shorten or lengthen the usable length of the rope which travels over the roller 150.

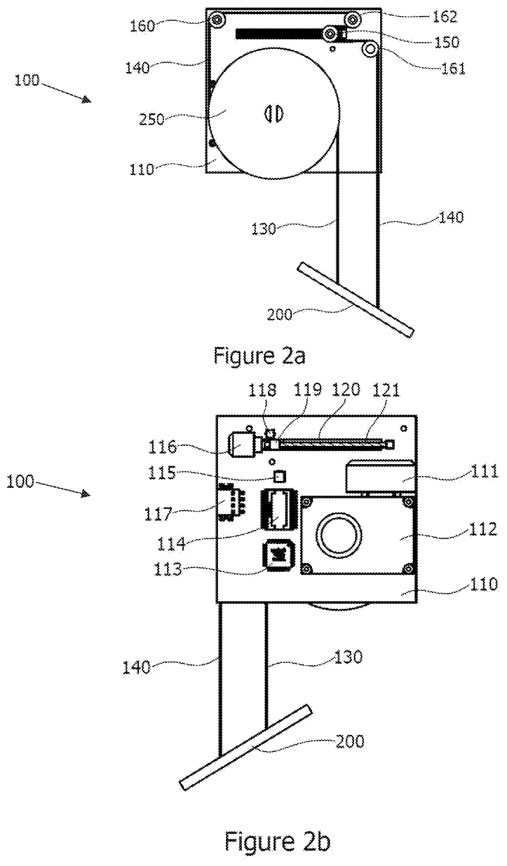

FIG. 2a shows a front view of a schematic illustration of a winch 100 according to some example implementations described herein.

FIG. 2a shows a winch 100 comprising a support frame 110, a rotatable drum 250, and two ropes 130, 140 wound on the rotatable drum 250 in a similar manner to that described in relation to FIG. 1a. In this example, the first rope 130 is wound on the rotatable drum 250 and directly coupled to the load 200. The second rope 140 is wound on the same rotatable drum 250 and is guided through the winch by the first fixed roller 160, the second fixed roller 162, the movable roller 150 and the third fixed roller 161. The second rope 140 is then directly coupled to the load 200. This configuration allows a greater vertical movement of the load 200, as the length of rope 130, 140 between the rotatable drum 250 and the load 200 can be greater.

FIG. 2b shows a rear view of a schematic illustration of a winch 100 according to some example implementations described herein.

FIG. 2b shows the rear side of the winch 100 shown in FIG. 2a. The rear side of the winch comprises a main motor 111, a gearbox 112, a winch controller 113, a main motor driver 114, a linear motor driver 115 for controller a linear motor 116, a power/data input connector 117, a switch 118 contactable by the moveable roller, a support 119, a support frame opening 120, and a screw 121.

The main motor 111 is coupled to, and driven by, the main motor driver 114. The main motor 111 is also coupled to the gearbox 112 and an output shaft, which in turn is coupled to the rotatable drum 250. This assembly allows for the rotatable drum 250 of the winch 100 to be rotated.

The winch controller 113 comprises a processor and a memory configured to control to movement of all parts of the winch 100. The controller 113 may control the winch 100 entirely on its own. Additionally or alternatively, the winch controller 113 may receive instructions from an external controller via a transceiver unit within the winch controller 113. The transceiver unit may also allow data to be sent to the external controller. In some examples, the winch controller 113 comprises the main motor 111 and/or the linear motor 116.

In any of the examples described herein, the ropes 130, 140 may be (electrically) conductive (to conduct data and/or electrical power). That is to say, the ropes 130, 140 themselves may be conductive and/or one or more of the ropes 130, 140 comprise an additional conductive wire. The conductive rope 130, 140 is then coupled to the load 200 in order to power it. Additionally or alternatively, data may be sent to and/or received from the load 200. The power and/or data is sent to and/or received from the load 200 via the power/data input connector 117. The power/data input connector 117 may comprise a processor and/or a memory and/or a transceiver unit. The transceiver unit may work similarly to (or in the same way as) the transceiver unit described in relation to the winch controller 113.

The linear motor 116 is driven by the liner motor driver 115. The linear motor 116 rotates the screw 121, which in turn moves the support 119 along the axial direction of the screw. The support 119 is coupled to the moveable roller 150 though the support frame opening 120. This allows for the moveable roller 150 to be moved at the same time and the same rate as the support 119. Support 119 and/or the moveable roller 150 may contact and activate the end position switch 118. This may, in some examples, be necessary for initial setup of the winch after power up and will be described in further detail below.

Any one or all of the above elements which are described as being on the rear side of the winch 100 may alternatively be on the front side of the winch 100, i.e. on the same side as the rotatable drum 250.

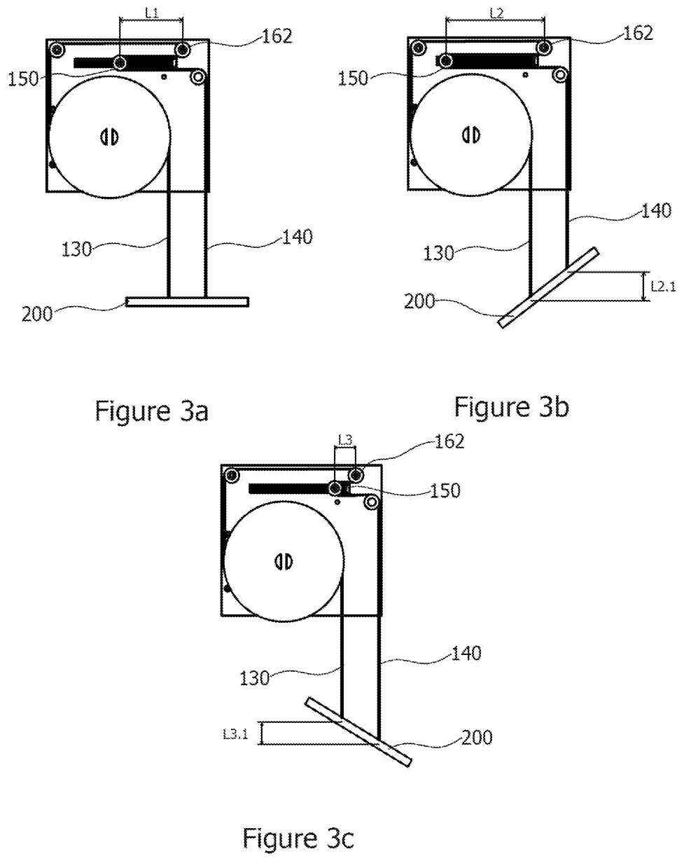

FIGS. 3a to c show front views of a schematic illustration of a winch 100 according to some example implementations described herein.

FIG. 3a shows the position of the moveable roller 150 in its initial position after power up. When the winch is powered up by the winch controller 113 or an external controller, the linear drive motor 116 rotates the screw 121 and moves the support 119 to one end of the screw 121 until it contacts the end position switch 118. The linear motor 116 then rotates the screw 121 in the opposite direction until the support 119 reaches the midpoint of the screw. The movable roller 150 is therefore placed at distance L1 from the end position switch 118 in the middle of frame opening 120.

FIG. 3b shows that by rotating the screw 121 in one direction, the movable roller 150 will be moved in one direction to distance L2 from the end position switch 118. In this case, the right side of the load 200, i.e. the side connected to the second rope 140, will be raised. The vertical distance between the ends of the two ropes 130, 140 is shown by distance L2.1.

FIG. 3c shows the opposite of FIG. 3b. That is to say the movable roller 150 will be moved in the opposite direction to distance L3 from the end position switch 118. In this case, the left side of the load 200 is lowered. The vertical distance between the ends of the two ropes 130, 140 is shown by distance L3.1.

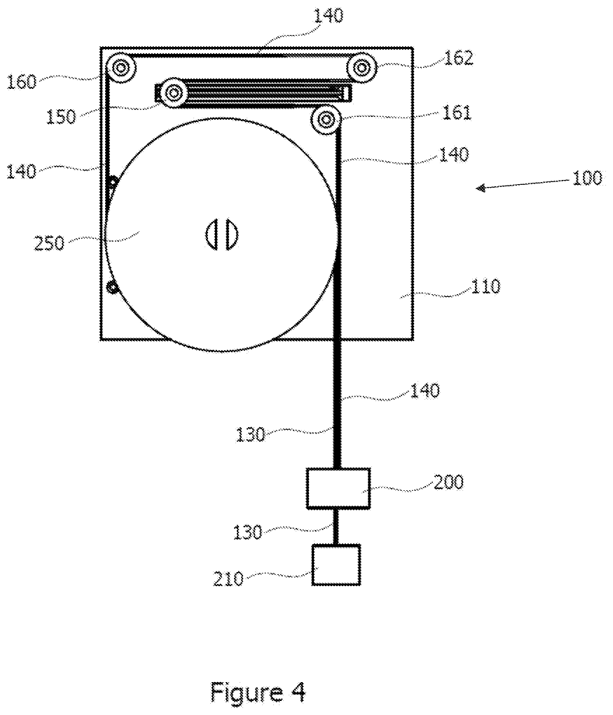

FIG. 4 shows a front view of a schematic illustration of a winch 100 according to some example implementations described herein.

FIG. 4 shows a winch 100 that may combine the features of the winches 100 shown in FIGS. 1b and 2a. The winch 100 comprises a support frame 110, two ropes 130, 140 coupled to the load 200 and a rotatable drum 250. The first rope 130 is wound on the rotatable drum 250, passed through the first load 200 and coupled to the second load 210. The second rope 140 is wound on the same rotatable drum 250 and is guided through the winch by the first fixed roller 160, the second fixed roller 162, the movable roller 150 and the third fixed roller 161. The second rope 140 is then coupled to the first load 200. In this example, the ropes 130 and 140 extend parallel and proximate to each other in the area of the loads 200, 210.

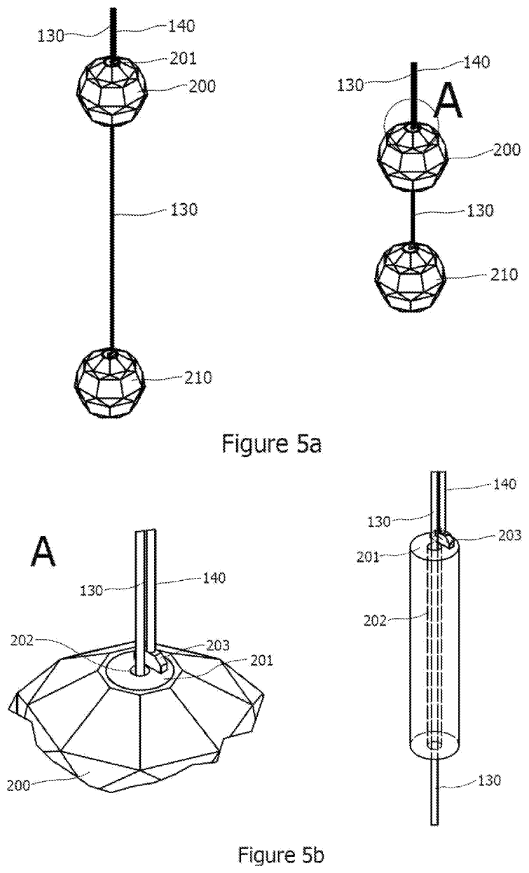

FIGS. 5a and 5b shows perspective views of a schematic illustration of the coupling between the ropes 130, 140 and the load 200 according to some example implementations described herein.

In FIG. 5a, the two loads 200, 210 are crystals. However, the loads 200, 210 may be any suitable load 200, 210. FIG. 5a further shows that the distance between the loads can be lengthened or shortened.

FIG. 5b shows a close up of the area highlighted in FIG. 5a. The first load 200 has a pass-through hole from pole to pole. This pass-through hole may alternatively enter and exit at any point of the first load 200.

Inside the pass-through hole, there is a support member 201. The support member 201 is fixed inside the first load 200, but may alternatively not be fixed. The support member 201 comprises a passage 202 for the first rope 130 that allows it to continue to the second load 210. The second rope 140 has a termination point 203 fixed on the support member 201. This termination point 203 can be of any design as long as it allows for the second rope 140 to be securely coupled to the support member 201 and thus, the first load 200.

One or both of the ropes 130, 140 can comprise electrically conducting strands/wires, and can supply electric current to one or both of the first load 200 and the second load 210. There can be any number of loads 200, 210 coupled to the winch 100 and the ropes 130, 140.

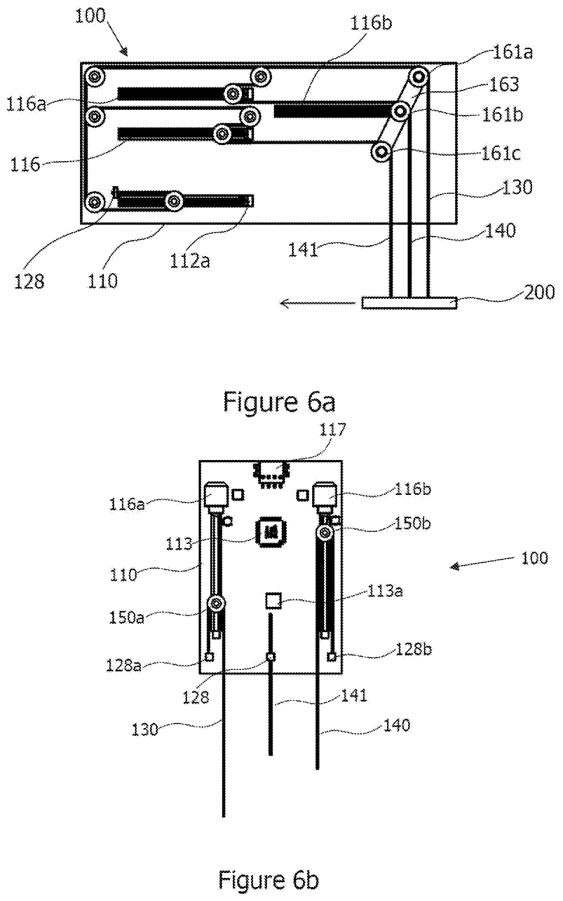

The support member 201 can be made from light scattering/diffusing plastic, glass or any other suitable material. The termination point 203 may comprise a light source to illuminate the first load 200 from inside the support member 201. The light source may be an LED, a tungsten bulb or any other suitable light source. FIGS. 6a and 6b show front views of a schematic illustration of a winch 100 according to some example implementations described herein.

In the example of the winch 100 shown in FIG. 6a, the main motor 111, the rotatable drum 250 and their respective components are replaced with a second linear motor 112a. In this example, there is also a third rope 141. All three ropes 130, 140, 141 are fixed at one common point 128 over the second movable roller coupled to the second linear motor 112a. The method of moving the second moveable roller is similar to that described in relation to the moveable roller 150 above in relation to FIGS. 1 and 2. The ropes 130, 140, 141 are all simultaneously moved as the second moveable roller moves along the screw driven by the second linear motor 112a. This therefore acts as a replacement for the rotatable drum 250. This layout results in a more compact winch 100.

The ropes 130, 140, 141 are guided through the winch by a series of fixed and moveable rollers. Each rope 130, 140, 141 is guided by a moveable roller which leads to each rope 130, 140, 141 being able to be moved individually, thereby leading to a more customizable manipulation of the load 200.

The ropes 130, 140, 141 are further guided by a series of rollers 161a, 161b, 161c fixed on a common support 163. The common support 163 is also coupled to a further linear motor 116b. The movement of the common support may be similar to (or the same as) that described in relation to the moveable roller above in relation to FIGS. 1 and 2 and allows for the common support 163, and therefore the load 200, to move in the horizontal direction. Resultantly, the load 200 can be moved in a horizontal direction, simultaneously with being moved in the vertical direction and the angle of the load 200 being adjusted.

FIG. 6b shows a further example implantation of the winch 100. In this example, there are two linear motors 116a and 116b to adjust the height of two of the three ropes 130, 140. The movement of the moveable rollers to which the two ropes 130, 140 are guided over has been described above in relation to the moveable roller 150 in FIGS. 1 and 2. The ropes 130, 140 are fixed on the frame 110 at first and second fixation points 128a, 128b respectively.

The third rope 141 is fixed to the frame 110 at a third fixation point 128. There is also a controller 113a configured to supply electrical signals/data via, for example, the third rope 141 to the load. These fixation points 128, 128a, 128b may be any type of fixation that allows the respective rope 130, 140, 141 to be securely coupled to the frame 110. An example of a fixation point 128, 128a, 128b is a fixed roller. Alternatively, the third rope 141 may be directly connected to the support frame 110.

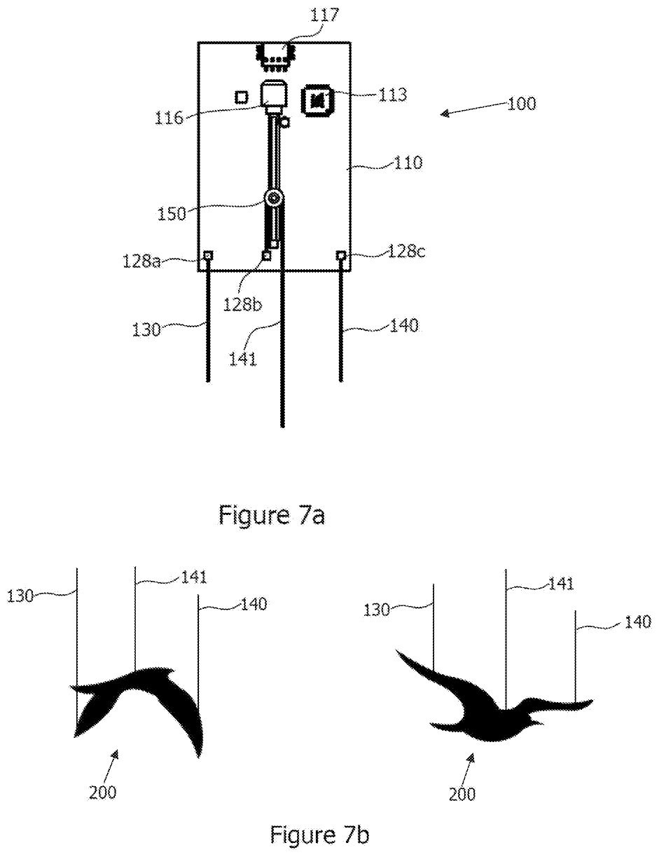

FIG. 7a shows a front view of a schematic illustration of a winch 100 according to some example implementations described herein.

FIG. 7a shows a winch 100 implementation which is the inverse of the winch 100 shown in FIG. 6b. That is to say, there is one linear motor 116 configured to adjust the height of the third rope 141, while the first and second ropes 130, 140 are fixed to the frame 110 at a first and second fixation point 128a, 128b. In any of the example implementations described herein, any of the ropes 130, 140, 141 can supply electric current and/or data to the load 200, 210 the ropes 130, 140, 141 are coupled to. The first and second ropes 130, 140 may be coupled to the frame 110 in a similar manner (or in the same way as) described above in relation to the third rope 141 in FIG. 6b.

FIG. 7b shows a load 200 manipulated by a winch 100 according to some example implementations described herein.

FIG. 7b shows a load 200 in the configuration of a bird with movable wings. The body of the bird is coupled to the winch 100 via the third rope 141 and the wings are coupled to the winch 100 via the first and second ropes 130, 140. By manipulating the height of one of the ropes 130, 140, 141, it is possible to create the effect of the bird flying. Furthermore, one or more of the ropes 130, 140, 141 can be coupled to a termination point, as described in relation to FIG. 5b, in order to illuminate the bird if there is a light source within the load body.

This is merely an example and manipulation of another load 200 with any other shape is also possible. Additionally, the supply of electrical signals/data is also possible by any of the ropes 130, 140, 141.

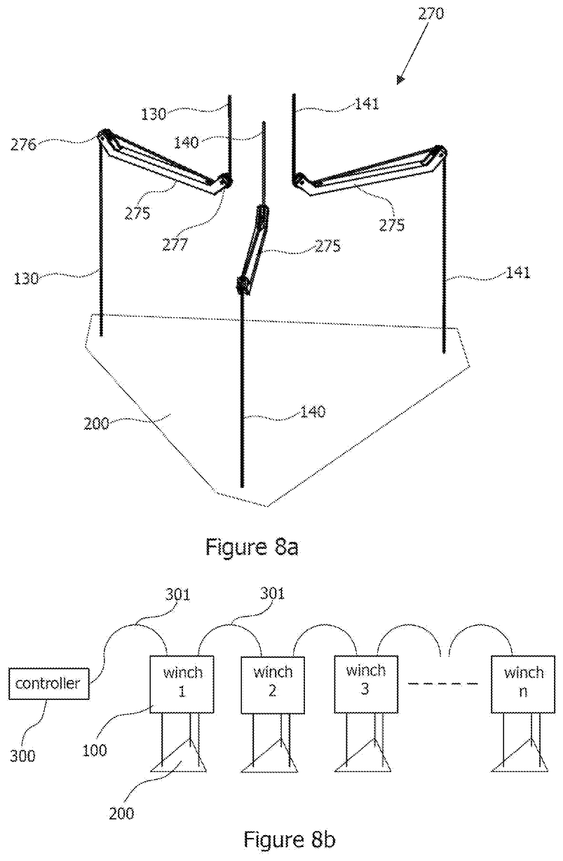

FIG. 8a shows a perspective view of a schematic illustration of a winch 100 configuration according to some example implementations as described herein.

The winch 100 shown in FIG. 8a further comprises a rope extender 270, which can be a part of the winch 100, or a separate element from the winch 100.

The rope extender 270 is configured to suspend a bulky large load 200. The load 200 in this example has a planar structure, for example, a lighting panel, a mirror, a frame etc. and has three suspension points where the ropes 130, 140, 141 couple to the load 200. The winch 100 (not seen in this figure) may be a winch 100 according to any of the implementations and examples described herein.

The rope extender arm 275 comprises two additional rollers 276, 277 in this example, but it can comprise any number of additional rollers 276, 277. The rope extender 270 may have only one arm 275 carrying one rope 130, 140, 141, whereas the other two ropes 130, 140, 141 may be suspended from the winch 100, as is described in any example implementation outlined herein, wherein the winch 100 comprises two ropes 130, 140, 141.

In the case of the winch 100 having only one rope extender arm 275, the arm 275 is configured to move from a position parallel to the support frame 110 to a position not parallel to the support frame 110. The arm 275 may be a telescopic arm. The arm 275 may be coupled to the support frame 110 by a hinge or any other suitable means and controlled by the winch controller 113 and/or an additional/external controller.

FIG. 8b shows a block diagram of a plurality of winches 100 according to some example implementations described herein.

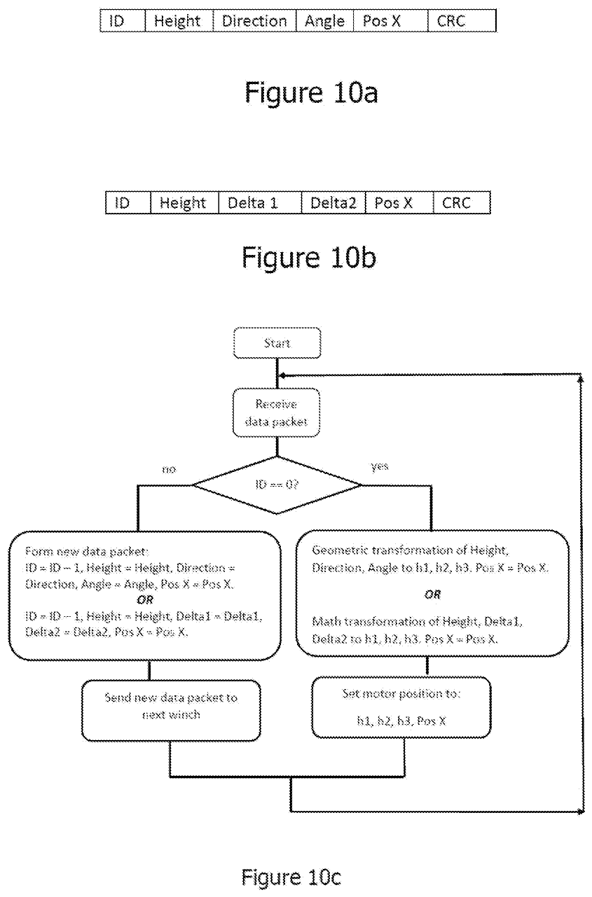

FIG. 8b shows a situation where a plurality of winches 100 need to be controlled. In this example, each winch 100 holds a respective load 200 and all winches 100 are controlled by main controller 300. The main controller 300 is configured to send power and/or data over a connecting cable 301 which couples the winches 100 to each other and to the main controller 300. It may also be possible to connect more than one winch directly to the controller 300. A method for controlling a plurality of winches 100 is described below in relation to FIGS. 10a to c.

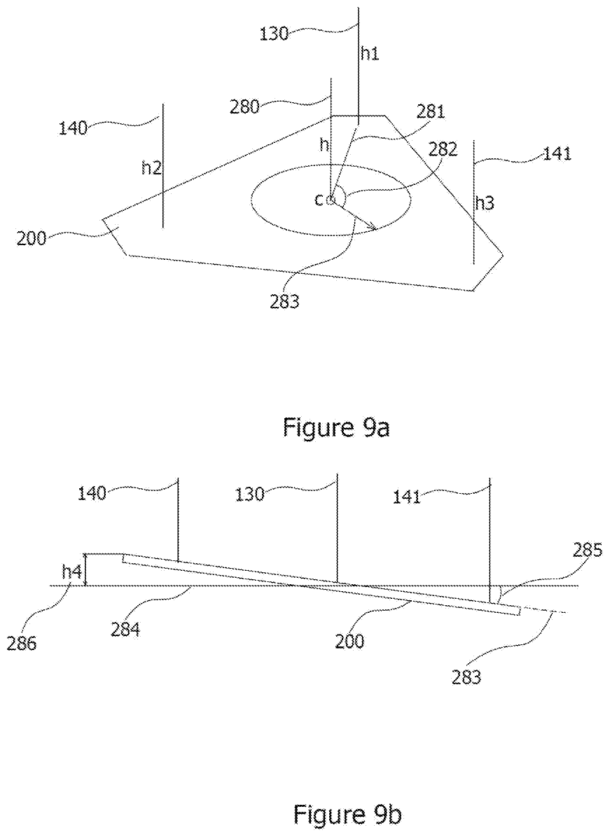

FIG. 9a shows a perspective view of a schematic illustration of a winch 100 according to some example implementations described herein.

FIG. 9a shows a winch substantially similar to that shown in FIG. 8a, but without the rope extender 270. The three ropes 130, 140, 141 coupled to the load are at three heights h1, h2, h3, wherein the heights are measured from a predetermined point on the winch 100. Additionally shown is point C. Point C is a center of load. In some examples, point C is the center of gravity of the load being manipulated. Additionally or alternatively, point C is the geometric center of a triangle formed by connection points of ropes 130, 140, 141 to the load 200.

Further shown is height h which is the distance between, for example, the bottom of the winch 100, i.e. the point of the winch 100 closest to the load 200, and point C. This height, h, 280, is measured in a direction substantially parallel to the direction of gravity.

The direction angle 282 is measured as the angle between the tilt direction line 283 (i.e. the direction of the lowest point of the load 200) and an imaginary line between point C and the connection point between the first rope 130 and the load 200. This direction angle may, in some examples, be recalculated for each of the ropes 130, 140, 141 coupled to the load 200.

FIG. 9b shows a side view of a load manipulated by the winch according to some example implementations described herein.

FIG. 9b shows the load 200 perpendicular to tilt direction line 283 shown in FIG. 9a.

The load 200 is tilted by manipulating the ropes 130, 140, 141 by the tilt angle 285. The tilt angle 285 is measured as the angle between the imaginary horizontal plane 284 (i.e a plane orthogonal to the direction of gravity) and the tilt direction line 283. In this example, as the tilt angle 285 is below the imaginary horizontal plane, the tilt angle 285 is negative. If the tilt angle 285 were above the imaginary horizontal plane, the tilt angle 285 would be positive. In some examples, the positive and negative labeling of the tilt angle 285 is reversed. In some examples, the tilt angle 285 is calculated for each rope 130, 140, 141 coupled to the load 200.

In this example, the left part of load 200 to which the second rope 140 is coupled is elevated. The height, h4, 286, (which may be named, in some examples, as the highest height point of the load) between the imaginary horizontal plane and the elevated part of the load 200 is equal to L2.1 shown in FIG. 3b. It is also possible for the winch 100, via one or more of the mechanisms described earlier, to lower the second rope 140 so that the distance between the left part of the load 200 and the imaginary horizontal plane is −h4, i.e. equal to L3.1 shown in FIG. 3C.

FIGS. 10a and 10b show examples of data tables processed by the winch according to some example implementations as described herein.

FIG. 10a shows a data table according to a first data protocol. The ID represents a winch number in the series of winches 100. For example, the first winch 100 in the series may have an ID number of 1, the second winch an ID number of 2 and so on. The ID numbers may be assigned in any fashion.

The method does not send height values for each rope 130, 140, 141 to the winch controller 113. Instead, in this example, for each rope 130, 140, 141, a singular height value is sent to the winch controller 113 which corresponds to the height of point C shown in FIG. 9a.

Furthermore, the values of the direction angle 282, the tilt angle 283 and the position at x-coordinate “Pos X”, which in the winch 100 shown in FIG. 6a corresponds to the horizontal position of the load 200, are also sent to the winch controller 113. Pos X may be calculated from a predetermined point on the winch 100. The CRC, cyclic redundancy check, is a piece of error checking code which checks the data packet sent to the winch controller 113 for any abnormalities.

In this example, the value of the direction angle 282 can be between 0-359 degrees. The value of the tilt angle 285 can be between +30 and −30 degrees. These parameters can be changed based on the physical dimensions of the load 200 and/or the size of the winch 100 and/or the length of the ropes 130, 140, 141.

FIG. 10b shows a data table according to a second data protocol. The ID number of each winch is assigned as described above in relation to FIG. 10a. One height value, h1, which corresponds to the height of the first rope 130, is sent to the winch controller 113.

Additionally, Delta1 and Delta2 values are sent to the winch controller 113. The Delta 1 and Delta 2 value correspond to:
For the second rope 140: Delta1;
For the third rope 141: Delta2.

Thus, the winch controller 113 may calculate the height, h2, h3, the second and third ropes 140, 141 by:

h2=h1+Delta1; Second rope 140 length:

h3=h1+Delta2. Third rope 141 length:

Pos X and CRC are the same as described above in relation to FIG. 10a. This data protocol is not constrained to being tied to the height, h1, of the first rope 130, but may use any rope 130, 140, 141 as a starting point.

FIG. 10c shows a block diagram of a method of controlling a winch according to some example implementations as described herein.

It is to be understood and appreciated that the present disclosure is not limited by the illustrated order, as some aspects could, in accordance with the present disclosure, occur in different orders and/or concurrently with other aspects from that shown and described herein. Moreover, not all illustrated features may be required to implement a methodology in accordance with an aspect of the present disclosure.

In this example, the method is performed by the winch controller 113 of each winch 100. In some examples, some or all of the winches 100 may undertake this method via an external controller.

Depending on the data protocol used, the method comprises:
Powering up and starting the winch 100.
Receiving the data packet;
Checking the winch ID: is it ‘zero’ or not;
In case of ID=zero:

a) FIG. 10a protocol: calculating h1, h2 and h3 by a geometric calculation routine, then setting and activating the linear motors 116, 116a, 116b so that their associated movable rollers are moved and the ropes 130, 140, 141 are moved to corresponding new height; or
b) FIG. 10b protocol: calculating h2=h1+Delta1 and h3=h1+Delta2 and then setting and activating the linear motors 116, 116a, 116b so that their associated movable rollers are moved and the ropes 130, 140, 141 are moved to corresponding new height; or
In case of ID=non-zero: deducting 1 from ID; forming a new data packet with the new ID and the values received from the data packet and sending the new data packet to next winch.

The method then begins again at the next winch 100 and so on until all of the winches 100 have received a data packet. This method allows for the reduction in the chance that a winch controller 113 is fed with data which may damage the winch 100. It also allows for winches to use different data protocols, as the data packet may contain data type for both protocols. Any other suitable type of data protocol may also be used when controlling the winches 100.

Embodiments and example implementations as described herein may allow for solving one or more of the following problems:

As outlined above, prior art systems achieve the raising and lowering of a load at an angle (e.g. to adjust the load angle and position) by using a plurality of winches. This results in a very large apparatus that is not suitable for compact spaces. Additionally, all winches need to be operational at the same time. Therefore, in the prior art, if one winch fails, all of the winches carrying the load need to be deactivated. Furthermore, data relating to each winch needs to be relayed to the other winches within the system thereby leading to a higher chance of corrupted and/or unusable data.

Another problem of prior art systems is that in some circumstances, the load bends in the middle if it is not made of a sufficiently rigid material. In order to solve this problem, the prior art teaches the use of multiple winches in order to compensate for the bending. This again may lead to a large apparatus with many individual components.

A further problem in the prior art is that if the thickness of the load is not uniform along its length, it can be difficult to coordinate the raising and the lowering of the load. The prior art solves this problem with multiple winches wherein each drum on each winch has a differing length of rope. This yet again leads to a large apparatus.

A further disadvantage with using multiple winches is that there is a greater chance of the load not being able to be raised and lowered due to one of the winches failing.

Another problem in the prior art is that there may be a need to move the load in a plane perpendicular to the plane or direction of the raising and the lowering of the load. This can yet again be very difficult if there are multiple winches, as every winch needs to be moved in a uniform manner.

In particular, one advantage of the winch and method as described herein according to any one or more of the example implementations is its safety: no matter which values will be transmitted/sent (to move a roller and/or (consequently a) load, or even if values are corrupted or incorrect, the physical (usable) rope lengths will be within limits of travel lengths of one or more linear motors. Even if a motor fails (that is a linear motor or a main motor, if used), it may not affect safety for operation the winch since limits of the rollers and/or ropes will not be exceeded. Thus, there is no need for any external safety devices.

No doubt many other effective alternatives will occur to the skilled person. It will be understood that the invention is not limited to the described embodiments and encompasses modifications apparent to those skilled in the art and lying within the scope of the claims appended hereto.

1. A winch (100) comprising:
a plurality of ropes (130, 140) coupleable to a first load (200) or to different respective second loads (200, 210);
a support frame (110); and
a first roller (150) moveably coupled to the support frame (110), wherein a first rope (150) of the plurality of ropes (130, 140) is moveable over the first roller (150);
wherein a movement of the first roller (150) is configured to shorten and/or lengthen a usable length of the first rope (140) of the plurality of ropes (130, 140), and wherein the shortening and/or lengthening of the usable length of the first rope (140) is configured to raise and/or lower the first load (200) or one of the second loads (200, 210) to which the first roller (150) is coupleable via the first rope (140).

2. The winch of claim 1, wherein the usable length of the first rope (140) is a length between the first roller (150) and a coupling of the first rope (150) to a said first load (200) or to a said respective second load (200, 210).

3. The winch (100) of claim 1 or 2, further comprising a second roller (160), wherein the second roller (160) is fixably coupled to the support frame (110), and wherein the first rope (130) of the plurality of ropes (130, 140) is moveable over the second roller (160).

4. The winch (100) of any one of the preceding claims, wherein the first roller (150) is coupled to an elongated member (121), wherein the elongated member (121) is rotatable about a longitudinal axis of the elongated member (121), and wherein upon a rotation of the elongated member (121) about the longitudinal axis, the first roller (150) is configured to move along said longitudinal axis of the elongated member (121).

5. The winch (100) of any one of the preceding claims, further comprising a switch (118) contactable by the first roller (150) and/or by a first roller support (119) of the first roller (150), wherein upon an establishment of a contact between the first roller (150) and the switch (118) and/or between the first roller support (119) and the switch (118), the winch (100) is configured to detect a position of the first roller (150).

6. The winch (100) of claim 5, when dependent on claim 4, wherein, during a setup procedure of the winch (100), the elongated member (121) is configured to be rotated in a first rotational direction about the longitudinal axis to move the first roller (150) towards the switch (118), and wherein upon said establishment of the contact between the first roller (150) and the switch (118), the elongated member (121) is configured to be rotated in a second rotational direction about the longitudinal axis to move the first roller (150) away from the switch to a position with a known first distance, L1, from the switch (118), wherein the second rotational direction is opposite to the first rotational direction.

7. The winch (100) of any preceding claim, further comprising:
a common support (163) which is moveably coupled to the support frame (110), and
a third roller (161a) and a fourth roller (161c) fixably coupled to the common support (163),
wherein a movement of the common support (163) is configured to move the first load (200) or one or more second loads (200, 210) in a direction having a component perpendicular to gravity.

8. The winch (100) of any preceding claim, further comprising an extension arm (275) comprising a fifth roller (276), wherein one or more of the plurality of ropes (130, 140) is moveable over the fifth roller (276).

9. The winch (100) of claim 8, wherein the extension arm (275) is moveable from a position adjacent to the support frame (110) to a position not adjacent to the support frame (110).

10. The winch (100) of claim 8 or 9, further comprising a rope extender (270) which comprises a plurality of extension arms (275), and wherein the rope extender (270) is suspended from the winch (100).

11. The winch (100) of any preceding claim, wherein the second loads (200, 210) are aligned in a direction substantially parallel to a direction of gravity, and wherein at least one of the second loads (200, 210) comprises a pass through hole configured to allow at least one of the plurality of ropes (130, 140) to pass through the at least one second load (200, 210).

12. A method for controlling a winch (100), in particular the winch (100) of any one of the preceding claims, wherein the winch (100) comprises:
a plurality of ropes (130, 140) coupleable to a first load (200) or to different respective second loads (200, 210),
a support frame (110),
a first roller (150) moveably coupled to the support frame (110), wherein a first rope (140) of the plurality of ropes (130, 140) is moveable over the first roller (150), and
a winch controller (113) configured to move the first roller (150) or to provide an output signal for moving the first roller (150);
and wherein the method comprises:
receiving, by the winch controller (113), from the winch (100), data comprising positional data of at least one of the plurality of ropes and/or a said first or second load (200, 210);
determining, by the winch controller (113), if the received data fulfils a condition;
wherein, if the condition is fulfilled, the method further comprises:
calculating, by the winch controller (113), length data relating to a usable length of at least one of the plurality of ropes (130, 140), wherein the usable length is changeable and/or a position of a said first or second load (200, 210) is raisable and/or lowerable by the winch (100); and
moving the first roller (150) to a location defined by a length difference which is determined based on the calculated length data and the received data, wherein the movement is configured to change the usable length of the at least one of the plurality of ropes (130, 140) and/or raise and/or lower a said first or second load (200, 210).

13. The method of claim 12, wherein the calculation comprises calculating one or more of:
a positon of a gravitational center of a said first and/or second load (200, 210);
a geometric center, C, of a said first and/or second load (200, 210);
a geometric center, C, of couplings of the plurality of ropes (130, 140) to a said first and/or second load (200, 210);
a tilt angle (285) of a said first and/or second load (200, 210); and
a direction (282) of a tilt of a said first and/or second load (200, 210).

14. The method of claim 12, wherein the calculation comprises calculating the usable length of each rope (130, 140) of the plurality of ropes (130, 140).

15. The method of any one of claims 12 to 14, wherein, if the condition is not fulfilled, the winch controller (113) prevents or stops:
calculating the length data, and/or
moving the first roller (150).
